(19) United States
(12) Patent Application Publication
(10) Pub. No.: US 2007/0168972 A1
(43) Pub. Date: Jul. 19, 2007

(54) Debugging a computer program

(75) Inventors: Cary L. Bates, Rochester, MN (US); Paul R. Day, Rochester, MN (US); Brian R. Muras, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/290,892

(22) Filed: Nov. 30, 2005

(51) Int. Cl. G06F 9/44

(52) U.S. Cl. 717/124

(57) ABSTRACT

Methods, apparatus, and computer program products are disclosed for debugging a computer program by operating a debugger step function, detecting a governor point by the debugger step function, and, responsive to detecting a governor point, disabling the debugger step function. Debugging a computer program also includes clearing a debugger input buffer of any pending step commands. Debugging a computer program also includes detecting control flow entry into a program control flow structure, recording a return point for each control flow entry into a program control flow structure, and, responsive to a user instruction to do so, continuing program execution to a recorded return point.

### BACKGROUND OF THE INVENTION

1. Field of the Invention

The field of the invention is data processing, or, more specifically, methods, apparatus, and products for debugging a computer program.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer software has become more sophisticated, computer programs called ‘debuggers’ that are used to analyze software defects or to optimize performance have also evolved. Debuggers allow a user to follow the flow of program execution and inspect the state of a program at any point by controlling execution of the program being debugged. Debuggers may control program execution through a variety of operations including a debugger step function.

A debugger step function is a function that instructs a computer processor to execute a single statement of computer program code and then to return processing control back to the debugger. A user typically operates a debugger step function by operating on a button of a graphical user interface or by operating a keyboard shortcut. Operating a debugger step function is often referred to as ‘stepping.’

After a brief sequence of stepping slowly, a user may gradually increase stepping speed through a block of computer program code until the user arrives at a line of computer program code of interest for debugging a computer program. Often, however, a user will step past the line of computer program code of interest without realizing that the user bypassed the line of computer program code of interest. For example, a user will often pass up the line of computer program code modifying a program variable because rapid stepping causes the user to step beyond the line of computer program code before noticing the variable was modified. Restarting the debugging process and arriving back at the line of computer program code of interest is often time consuming and difficult.

On other occasions, a user may enter a loop or a function call path while stepping through a sequence of computer program code. Entry into a loop or function call path may occur because the user steps into the loop or function call path while stepping through a block of computer program code. Often, the user fails to notice the control flow entry into the loop or the function call path until the user has executed a number of lines of computer program code inside the loop or function call path because of the user's rapid stepping.

Entry into a loop or function call path may also occur because a debugger encounters a breakpoint when the user steps over the loop or function call path. When a debugger stops program execution inside the loop or function call path, a user often may become disoriented regarding the location of the breakpoint and have difficulty returning to the location in the computer program code where control flow exits the loop or function call path.

### SUMMARY OF THE INVENTION

Methods, apparatuses, and computer program products are disclosed for debugging a computer program by operating a debugger step function, detecting a governor point by the debugger step function, and, responsive to detecting a governor point, disabling the debugger step function. Debugging a computer program also may include clearing a debugger input buffer of any pending step commands. Debugging a computer program may be carried out by disabling the debugger step function pending user authorization to continue stepping. Debugging a computer program may include disabling the debugger step function for a predetermined period of time. Debugging a computer program may include an attribute of a user breakpoint, an attribute of a watch point, an attribute of a function call, and an attribute of a line of computer program code.

Debugging a computer program may be carried out by detecting control flow entry into a program control flow structure, recording a return point for each control flow entry into a program control flow structure, and, responsive to a user instruction to do so, continuing program execution to a recorded return point. Debugging a computer program also may include operating a step-in function of a debugger to cause control flow entry into a program control flow structure. Debugging a computer program may also include prompting the user to select a recorded return point and may be carried out by continuing program execution to a user-selected recorded return point regardless of any intervening user breakpoints.

Debugging a computer program also may include operating a step-over function of a debugger to cause control flow over a program control flow structure, where the program control flow structure contains a user breakpoint; stopping program execution inside the control flow structure at the user breakpoint; and prompting the user for an indication whether to continue execution to a recorded return point. Debugging a computer program may also include prompting the user to select a recorded return point and may be carried out by continuing program execution to a user-selected recorded return point regardless of any intervening user breakpoint.

Debugging a computer program may include a loop and may be carried out by identifying a next line of computer program code after the loop as a return point for the loop. Debugging a computer program may include a function call path that includes one or more function calls and may be carried out by recording a next line of computer program code after one or more function calls of the function call path.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in debugging a computer program according to embodiments of the present invention.

FIG. 2 sets forth a line drawing of an exemplary debugger graphical user interface of a debugger that supports debugging a computer program according to embodiments of the present invention.

FIG. 3 sets forth a flow chart illustrating an exemplary method for debugging a computer program according to embodiments of the present invention.

FIG. 4 sets forth a flow chart illustrating a further exemplary method for debugging a computer program according to embodiments of the present invention.

FIG. 5 sets forth a flow chart illustrating a further exemplary method for debugging a computer program according to embodiments of the present invention.

FIG. 6 sets forth a flow chart illustrating a further exemplary method for debugging a computer program according to embodiments of the present invention.

### DETAILED DESCRIPTION OF EXEMPLARY EMBODIMENTS

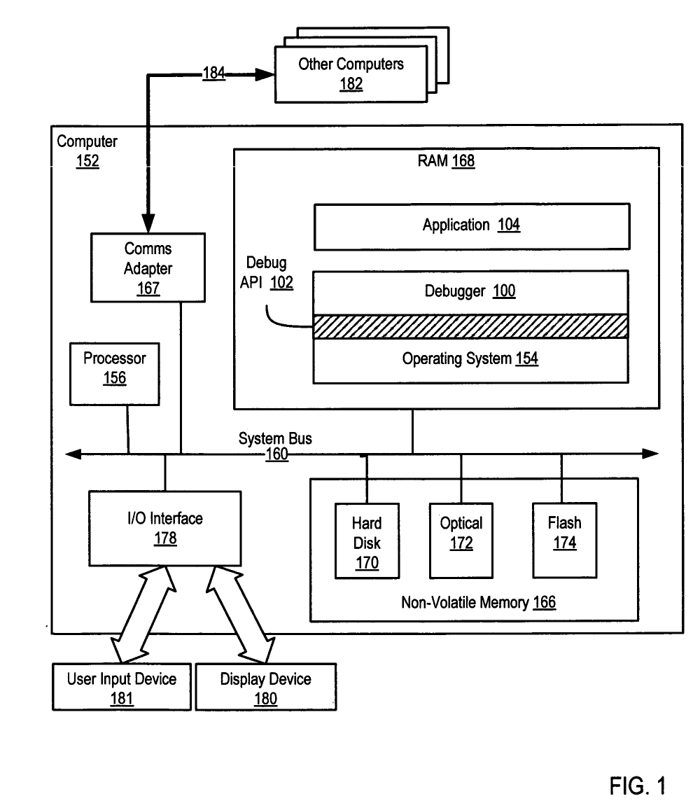

Exemplary methods, apparatus, and products for debugging a computer program according to embodiments of the present invention are described with reference to the accompanying drawings, beginning with FIG. 1. Debugging a computer program in accordance with the present invention is generally implemented with computers, that is, with automated computing machinery. For further explanation, therefore, FIG. 1 sets forth a block diagram of automated computing machinery comprising an exemplary computer (152) useful in debugging a computer program according to embodiments of the present invention.

The system of FIG. 1 includes a debugger (100). A debugger is a computer program that is used to analyze software defects in another computer program or to analyze performance of another computer program. A debugger assists in the analysis of software defects and analysis of performance by controlling the execution of a computer program by a computer processor. Examples of debuggers that may be improved to operate according to embodiments of the present invention include the Turbo Debugger, Borland C++Integrated Debugger, the GNU Project Debugger, the IBM Debug Tool, the Microsoft Windows Debugger, or any other debugger as will occur to those of skill in the art.

Debugger (100) is improved according to embodiments of the present invention for operating a debugger step function, detecting a governor point by the debugger step function, and, responsive to detecting a governor point, disabling the debugger step function. A debugger step function is a function that instructs a computer processor to execute a single statement of computer program code and then to return processing control back to the debugger. A debugger step function may be implemented by inserting an internal breakpoint between the current line of computer program code to be executed and the next line of computer program code. In this specification, calling a debugger step function is sometimes referred to as ‘stepping.’

A breakpoint is a special instruction inserted into executable computer machine code of a computer program that stops execution of the computer machine code by a processor and returns processor control through an operating system to a debugger. Special instructions used as breakpoints are defined by a computer processor's architecture and may include, for example, an illegal opcode or a dedicated breakpoint instruction inserted into the computer machine code of a computer program.

A debugger may insert a breakpoint directly into computer machine code to carry out the debugger's own program operations. A breakpoint inserted directly into computer machine code to carry out the debugger's own program operations is referred to in this specification as an ‘internal breakpoint.’ For example, a debugger may insert an internal breakpoint directly after a line of computer program code to carry out a debugger step function. Internal breakpoints inserted by a debugger to carry out the debugger's own program operations are not visible to a user of a debugger. In addition to internal breakpoints inserted by a debugger to carry out the debugger's own program operations, a user may insert a breakpoint into computer program code through a user interface for debugging a computer program. A breakpoint inserted by a user through a user interface is referred to in this specification as a ‘user breakpoint.’

Computer machine code is a system of numeric codes directly executable by a computer processor. A computer machine code may, for example, instruct a computer processor to store the sum of a first register and a second register into the first register. Computer machine code is computer processor dependent, and computer machine codes therefore vary from one computer processor to another.

Computer machine code is typically generated from computer program code. Computer program code is a series of statements written in some human-readable computer programming language such as, for example, Java, C++, Visual Basic, SQL, Fortran, or assembly language. Computer program code is typically organized in lines, each line containing one or more statements. Computer program code is converted into computer machine code either by a compiler for a particular computer processor, by an assembler for an assembly language for a particular computer processor, or on the fly from a human-readable form with the aid of an interpreter. In this specification, both a computer machine code and a computer program code, alone or in combination, are referred to as a ‘computer program instruction.’

A governor point is an indication for determining whether to disable a debugger step function until a user authorizes enabling the debugger step function. A governor point may, for example, be implemented as an attribute of a user breakpoint, an attribute of a watch point, an attribute of a function call, or an attribute of a line of computer program code. In this specification, any user breakpoint, watch point, function call, or line of computer program code with an attribute set to disable a debugger step function is referred to as a ‘governor point.’ Any user breakpoint, watch point, function call, or line of computer program code with no attribute set to disable a debugger step function is respectively referred to as a ‘user breakpoint,’‘watch point,’ ‘function call,’ or ‘line of computer program code.’

A watch point is a user breakpoint that is associated with a particular variable or data location. Accessing the particular variable or data location causes computer program execution to stop at the location in the computer machine code modifying the variable. Watch points may be used, for example, to detect, or ‘watch,’ when the values stored in a data structure change as computer program instructions in a loop operate on the data structure.

In the example of FIG. 1, debugger (100) is also improved according to embodiments of the present invention to clear a debugger input buffer of any pending step commands. A debugger input buffer is a portion of memory set aside to store user instructions for control of a debugger as data is received from an external device such as, for example, a keyboard or a mouse. Pending step commands are function calls to a debugger step function stored in a debugger input buffer. Such commands may be pending because the commands were entered by a user after program execution stopped upon encountering a governor point.

In the example of FIG. 1, debugger (100) is also improved according to embodiments of the present invention to detect control flow entry into a program control flow structure, recording a return point for each control flow entry into a program control flow structure, and, responsive to a user instruction to do so, continuing program execution to a recorded return point. Control flow is the order in which computer program instructions are executed by a computer processor. A program control flow structure is one or more computer program instructions that alter the sequence in which other program instructions are executed. A program control flow structure may be implemented, for example, as a conditional statement, a loop, or a call to a subroutine. Examples of control flow structures useful for debugging a computer program according to embodiments of the present invention include ‘IF-THEN-ELSE,’ ‘WHILE,’ ‘DO-WHILE,’ ‘FOR,’ and any other control flow structure as will occur to those of skill in the art. A return point is a first computer program instruction following control flow exit from a control flow structure.

In the example of FIG. 1, debugger (100) is also improved according to embodiments of the present invention to operate a step-in function of a debugger to cause control flow entry into a program control flow structure. A step-in function is a debugger function that instructs a computer processor to execute a statement of computer program code representing a control flow entry into a new program control flow structure and then to return control of the computer processor back to the debugger at the first statement of the new program control flow structure. Continuing stepping typically then will step through program instructions inside the control flow structure. Debugger (100) is also improved to prompt a user to select a recorded return point.

In the example of FIG. 1, debugger (100) is also improved according to embodiments of the present invention to operate a step-over function of a debugger to cause control flow over a program control flow structure, the program control flow structure containing a user breakpoint, stopping program execution inside a control flow structure at a user breakpoint, and prompting a user for an indication whether to continue execution to a recorded return point.

A step-over function is a debugger function that instructs a computer processor to execute a statement of computer program code representing a control flow entry into a new program control flow structure, execute all the program instructions inside the control flow structure, and then to return control of the computer processor back to the debugger at the return point for the control flow structure.

The computer (152) of FIG. 1 includes at least one computer processor (156) or ‘CPU’ as well as random access memory (168) (‘RAM’) which is connected through a system bus (160) to processor (156) and to other components of the computer. Processor (156) provides features useful to a debugger in debugging a computer program. Features of processor (156) useful in debugging may include the ability to specify a breakpoint by providing a debugging opcode of the processor specifically for that purpose. Processor (156) may provide an ‘interrupt’ or ‘trap’ feature that vectors control flow to a debugger when the processor encounters a debugging opcode. A debugging opcode and a debugging interrupt provide processor (156) with the ability to notify an operating system that a debugging event has occurred with respect to a process or thread running on the processor; the operating system then may notify a debugger of the debugging event by, for example, vectoring the interrupt to a debugging module in computer memory. In addition, a computer processor provides the ability to read and write directly out of and into the computer processor registers when a debugging interrupt occurs.

Stored in RAM (168) is an operating system (154). An operating system is the computer program responsible for the direct control and management of computer hardware and of basic computer system operations. Operating system (154) provides hardware and system control and management to a debugger through a debug application programming interface (‘API’) (102). Debug API (102) is a set of functions or software routines provided by operating system (154) for use by debuggers. Examples of the kinds of functions that may be included in debug API (102) include functions that enable a debugger to read values from and set values in memory, read and set values in processor registers, suspend and resume thread processing, and so on. Operating systems useful in computers according to embodiments of the present invention include UNIX™, Linux™, Microsoft XP™, AIX™, IBM's i5/OS™, and others as will occur to those of skill in the art.

Also stored in RAM (168) is an application (104), a computer software program for carrying out user-level data processing. In the example of FIG. 1, debugger (100) provides debugging of application (104). Operating system (154), debugger (100), and application (104) in the example of FIG. 1 are shown in RAM (168), but many components of such software typically are stored in non-volatile memory (166) also.

Computer (152) of FIG. 1 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

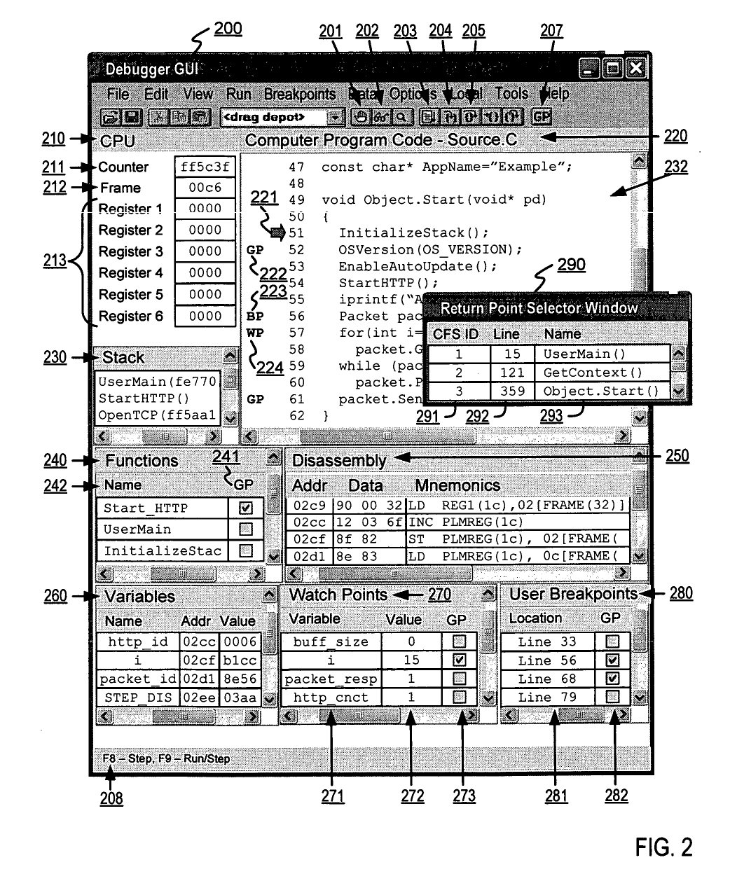

The example computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice. Debugger (100), for example, controls a display screen through an output interface adapter, such as a video adapter, to provide a graphical user interface (‘GUI’), such as the one described below with reference to FIG. 2, for use in debugging a computer program according to embodiments of the present invention.

The exemplary computer (152) of FIG. 1 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11 b adapters for wireless network communications.

For further explanation, FIG. 2 sets forth a line drawing of an exemplary debugger GUI (200) of a debugger that supports debugging a computer program according to embodiments of the present invention. In the example of FIG. 2, debugger GUI (200) displays a GUI step button (203) for operating a debugger step function. In addition to providing a GUI step button to operate a debugger step function, the user interface of FIG. 2 also provides a keyboard shortcut (208) for operating a debugger step function. Debugger GUI (200) provides a text block (232) in which a debugger displays a segment of computer program instructions presently affected by debugging operations. Each call to the debugger step function moves a step cursor (221) to the line of computer program code containing the next statement of computer program code for execution by a computer processor.

In the example of FIG. 2, debugger GUI (200) displays a GUI step-in button (204) for operating a step-in function of a debugger. The step-in function causes control flow entry into a program control flow structure. Operating the step-in function while the step cursor (221) is located on a control flow entry point, such as, for example, line 51 of computer program code (220), moves the step cursor (221) to the line containing the first statement of computer program code inside the control flow structure entered. In addition to moving the step cursor (221), a return point selector window (290) displays a return point for the control structure entered when a user operates a step-in function of a debugger.

In the example of FIG. 2, debugger GUI (200) displays a return point selector window (290), a GUI for prompting a user to select a recorded return point. Return point selector window (290) depicts data associating a control flow structure identifier (291), a return point represented as a line (292) of computer program code, and a control flow structure name (293).

In the example of FIG. 2, debugger GUI (200) displays a GUI button (205) for operating a step-over function of a debugger to cause control flow entry over a program control flow structure. Operating the step-over function while the step cursor (221) is located on a control flow entry point, such as, for example, line 51 of computer program code (220), moves the step cursor (221) to the line containing the next statement of computer program code in the current control flow structure such as, for example, line 52 of computer program code (220).

In the example of FIG. 2, debugger GUI (200) displays a GUI button (201) for inserting a user breakpoint into computer program code (200). A user breakpoint inserted into computer program code (200) is represented by a ‘BP’ (223) next to a line number of computer program code (200) and appears in a user breakpoints section (280) of debugger GUI (200).

The user breakpoints section (280) of debugger GUI (200) in the example of FIG. 2 displays a list of all user breakpoints in computer program code (220). A governor point (282) is implemented as an attribute of a user breakpoint in the example of FIG. 2. The user breakpoints section (280) therefore depicts data associating a user breakpoint location (281) with a governor point (282).

In the example of FIG. 2, debugger GUI (200) displays a watch point icon (202) for associating a watch point with a variable. A watch point associated with a variable is represented by a ‘WP’ (224) next to a line number of computer program code (200) that accesses the variable. In the example of FIG. 2, when the computer program instructions at line number 57 of computer program code (200) accesses the variable ‘i,’ processor control returns to the debugger.

In the example of FIG. 2, a watch point associated with a variable also appears in a watch points section (270) of debugger GUI (200). The watch point (270) section of debugger GUI (200) displays a list of all watch points in computer program code (220). A governor point (273) is implemented as an attribute of a watch point. The watch point section (270) therefore depicts data associating a watch point variable (271) to monitor for a particular value (272) with a governor point (273).

In the example of FIG. 2, a governor point (241) is also implemented as an attribute of a function call. Debugger GUI (200) therefore includes a functions section (240) that depicts data associating a function (242) with a governor point (241) for all functions in computer program code (200). When step cursor (221) reaches a function that has a governor attribute set, disabling the debugger step function occurs. In the example of FIG. 2, a governor point (222) is further implemented as an attribute of a line of computer program code. Debugger GUI (200) therefore depicts data associating a governor point (222) with line 52 of computer program code (200). When step cursor (221) reaches line 52 of computer program code (200) in the example of FIG. 2, disabling the debugger step function occurs. Operating the ‘GP’ button (207) of debugger GUI (200) associates a governor point with a line of computer program code. GP (222) at line 54 of the computer program code display (232) is an example a governor point associated with a line of computer program code.

In the example of FIG. 2, debugger GUI (200) includes a CPU section (210) that depicts information regarding the state of a processor executing the computer machine code represented by computer program code (220). The CPU section (210) of debugger GUI (200) displays the values contained in program counter (211), frame counter (212), registers (213), and stack (230). A program counter is a register in the CPU that points to a memory location for the next instruction to be executed by a processor. The value of the program counter changes after each instruction is executed, either by incrementing the program counter by the length of the previous instruction or due to a branch to a new memory location containing a new instruction. A stack is a run-time data structure that stores data last-in, first-out.

Debugger GUI (200) in the example of FIG. 2 includes a disassembly section (250). The disassembly section (250) displays assembly language for computer machine code executing on a processor. The disassembly section (250) in the example of FIG. 2 depicts data associating computer machine code data, a memory address containing the data, and assembly language mnemonics of the data.

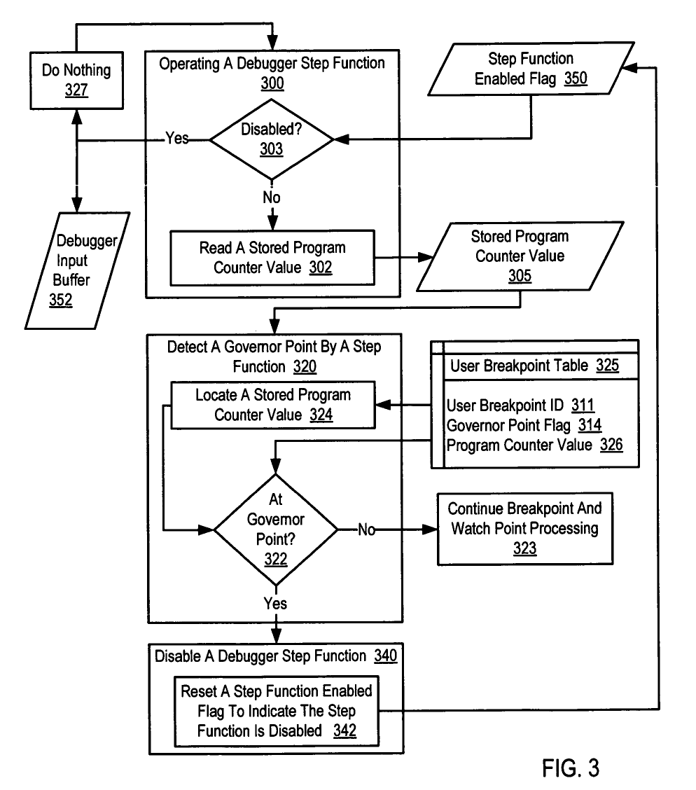

In the example of FIG. 2, debugger GUI (200) includes a variables section (260). The variables section (260) contains a list of all variables in computer program code (220). The variable section (260) in the example of FIG. 2 depicts data associating a variable name, a current value, and a memory address for storing the value. For further explanation, FIG. 3 sets forth a flow chart illustrating an exemplary method for debugging a computer program according to embodiments of the present invention that includes operating (300) a debugger step function, detecting (320) a governor point by the debugger step function, and, responsive to detecting a governor point, disabling (340) a debugger step function.

The method of FIG. 3 includes operating (300) a debugger step function. Operating (300) a debugger step function may be carried out by a user's operating a GUI button of a user interface that invokes a debugger step function. Operating (300) a debugger step function may also be carried out by a user's operating a keyboard shortcut of a user interface that invokes a debugger step function.

The debugger step function itself may be implemented as computer program instructions that insert an internal breakpoint after each statement of computer program code. Inserting an internal breakpoint after each statement of computer program code stops execution of a computer program under debug and returns processor control to a debugger. As mentioned above, a debugger inserts these internal breakpoints into computer machine code to provide a stepping feature for executing one line of computer program code at a time; internal breakpoints used in implementing a debugger step function are not visible to a user.

Operating (300) a debugger step function according to the method of FIG. 3 includes determining (303) whether a debugger step function is disabled. Determining (303) whether a debugger step function is disabled according to the method of FIG. 3 may be carried out by reading a step function enabled flag (350). Step function enabled flag (350) may be implemented as a data element in a debugger data structure such as, for example, an element in a table of debugger system variables. A step function enabled flag (350) value of FALSE indicates that the debugger step function is disabled, while a step function enabled flag (350) value of TRUE indicates that the debugger step function is enabled.

If a debugger step function is disabled, the method of FIG. 3 continues by doing (327) nothing, looping around to accept another operation of a debugger step function (300). Doing (327) nothing according to the method of FIG. 3 indicates that a debugger does not execute a pending step command stored in the debugger input buffer (352). Debugger input buffer (352) is represented as a data structure that stores data as the data is received from an external device such as, for example, a keyboard or a mouse. Such unexecuted pending step commands may accumulate in the debugger input buffer (352). Such accumulated step commands may later be executed when the debugger step function is again enabled. Alternatively a debugger may be programmed or instructed to clear the debugger input buffer of any pending step commands when the debugger step function is again enabled.

If a debugger step function is enabled, operating (300) a debugger step function according to the method of FIG. 3 includes reading (302) a stored program counter value (305). Stored program counter value (305) is the value of a computer processor's program counter when the processor encountered an internal breakpoint. After encountering an internal breakpoint, an interrupt handler or operating system function stores the values of the processor's hardware registers, including the current value of the program counter, in computer memory and transfers processor control to a debugger. A debugger may then read (302) the stored program counter value (305) by invoking a function of a debug API such as, for example, invoking UNIX's ‘PIOCGREG’ command through the ‘ioctl()’ function or Win32's ‘GetThreadContext’ function.

The method of FIG. 3 includes detecting (320) a governor point by the debugger step function. In the method of FIG. 3, user breakpoint table (325) is a data structure that associates a user breakpoint identifier (311), a governor point flag (314), and a program counter value (326). Detecting (320) a governor point by the debugger step function according to the method of FIG. 3 includes locating (324) a stored program counter value (305) in user breakpoint table (325).

After locating (324) the user breakpoint (311) and the governor point flag (314) for the stored program counter value (305), detecting (320) a governor point by the debugger step function according to the method of FIG. 3 includes determining (322) whether a user breakpoint (311) is a governor point. Determining whether a user breakpoint (311) is a governor point may be carried out by reading a governor point flag (314). If the governor point flag (314) is reset to FALSE, then the governor point flag's associated user breakpoint (311) is not a governor point. A user breakpoint (311) is a governor point, however, if its governor point flag (314) is set to TRUE. The method of FIG. 3 continues (323) with normal user breakpoint processing if a current user breakpoint (311) is not a governor point.

If a user breakpoint is a governor point, the method of FIG. 3 includes disabling the debugger step function. That is, the method of FIG. 3 includes, responsive to detecting a governor point, disabling (340) a debugger step function. Disabling (340) a debugger step function according to the method of FIG. 3 may be carried out by resetting (342) to FALSE a step function enabled flag (350) to indicate the step function is disabled. When a user invokes a debugger step function through a user interface, a debugger may therefore include reading a step function enabled flag (350) to determine (303) whether a debugger step function is disabled.

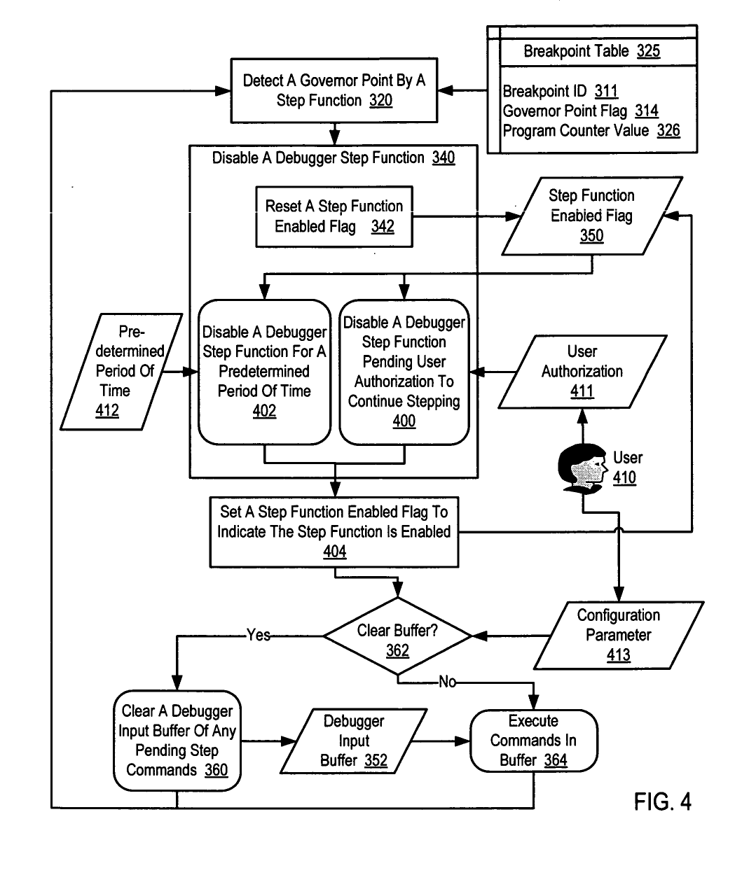

For further explanation, FIG. 4 sets forth a flow chart illustrating a further exemplary method for debugging a computer program according to embodiments of the present invention that includes detecting (320) a governor point by the debugger step function, responsive to detecting a governor point, disabling (340) a debugger step function, and clearing (360) a debugger input buffer (352) of any pending step commands. Detecting (320) a governor point by the debugger step function according to the method of FIG. 4 operates in a manner similar to detecting (320) a governor point as described with reference to FIG. 3. Detecting (320) a governor point by the debugger step function according to the method of FIG. 4 includes locating a stored program counter value in user breakpoint table (325) and determining whether a user breakpoint (311) is a governor point. In the method of FIG. 4, user breakpoint table (325) is a data structure that associates a user breakpoint identifier (311), a governor point flag (314), and a program counter value (326).

If a user breakpoint is a governor point, the method of FIG. 4 includes disabling the debugger step function. That is, the method of FIG. 4 includes, responsive to detecting a governor point, disabling (340) a debugger step function. Disabling (340) a debugger step function according to the method of FIG. 4 may be carried out by resetting (342) to FALSE a step function enabled flag (350) to indicate the step function is disabled. Step function enabled flag (350) in the example of FIG. 4 may be implemented as a data element in a debugger data structure such as, for example, an element in a table of debugger system variables. A step function enabled flag (350) value of FALSE indicates that the debugger step function is disabled, while a step function enabled flag (350) value of TRUE indicates that the debugger step function is enabled. When a user invokes a debugger step function through a user interface, a debugger may read a step function enabled flag (350) to determine whether a debugger step function is disabled.

In the method of FIG. 4, disabling (340) a debugger step function may be carried out by disabling (400) a debugger step function pending user authorization (411) to continue stepping. In the example of FIG. 4, data structure (411) represents a user's authorization to continue stepping. A user's authorization to continue stepping may be indicated by a user's response to a prompt in a GUI dialog box notifying the user that the step function is disabled and asking whether the user wishes to authorize continued stepping. Also in the method of FIG. 4, disabling (340) a debugger step function may be carried out by disabling (402) a debugger step function for a predetermined period of time (412)—as an alternative to disabling (400) a debugger step function pending user authorization (411) to continue stepping. In this example, after expiration of a predetermined period of time or in the presence of an affirmative authorization from a user to enable stepping, the method of FIG. 4 continues by setting (404) a step function enabled flag (350) to indicate the debugger step function is now again enabled.

The method of FIG. 4 continues by determining (362) whether to clear the debugger input buffer (352) of any pending step commands. The debugger determines (362) whether to clear the debugger input buffer (352) by reading a configuration parameter (413). The configuration parameter (413) is a flag set by the user (410) to indicate whether the debugger clears the debugger input buffer (352) when the debugger enables the debugger step function. A configuration parameter (413) value of TRUE indicates that the debugger clears the debugger input buffer (352) when the debugger enables the debugger step function. A configuration parameter (413) value of FALSE indicates that the debugger executes the step commands in the debugger input buffer (352) when the debugger enables the debugger step function.

If the value of the configuration parameter (413) is TRUE, the method of FIG. 4 continues by clearing (360) a debugger input buffer (352) of any pending step commands. Clearing (360) a debugger input buffer (352) of any pending step commands may be carried out by deleting all pending step command entries in a debugger input buffer (352). After clearing (360) a debugger input buffer (352), the method of FIG. 4, again, detects (320) a governor point by a step function, disables a debugger step function (340), and so on.

If the value of the configuration parameter (413) is FALSE, the method of FIG. 4 continues by executing (364) the pending step commands in the debugger input buffer (352). The debugger may execute (364) the pending step command in the debugger input buffer (352) by processing a step command in the debugger input buffer (352), deleting the pending step command entry from the buffer (352), processing the next step command in the buffer (352), and so on until all the debugger processes all the step commands in the buffer (352). After executing (364) the pending step commands, the method of FIG. 4, again, detects (320) a governor point by a step function, disables a debugger step function (340), and so on.

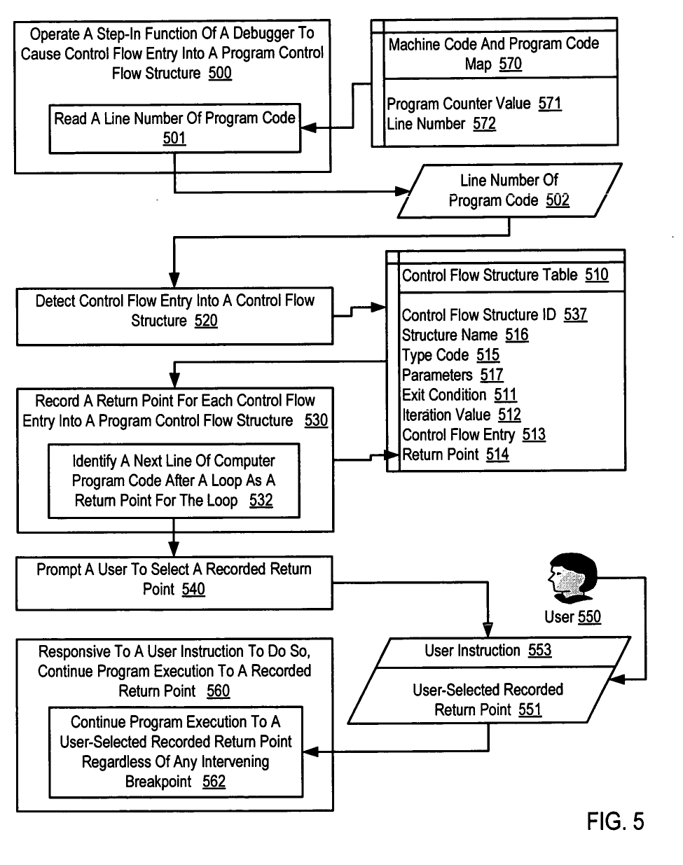

For further explanation, FIG. 5 sets forth a flow chart illustrating a further exemplary method for debugging a computer program according to embodiments of the present invention that includes operating (500) a step-in function of a debugger to cause control flow entry into a program control flow structure, detecting (520) control flow entry into a program control flow structure, recording (530) a return point for each control flow entry into a program control flow structure, prompting (540) the user to select a recorded return point, and responsive to a user instruction to do so, continuing (560) program execution to a recorded return point.

The method of FIG. 5 includes operating (500) a step-in function of a debugger to cause control flow entry into a program control flow structure. Operating (500) a step-in function of a debugger may be carried out by a user's operating a GUI button of a user interface that invokes a step-in function of a debugger. Operating (500) a step-in function of a debugger may also be carried out by a user's operating a keyboard shortcut of a user interface that invokes a step-in function of a debugger.

The step-in function of a debugger itself may be implemented as computer program instructs that insert an internal breakpoint after the first statement of computer program code in a program control flow structure to be entered using the step-in function. Inserting an internal breakpoint after first statement of computer program code in a program control flow structure to be entered stops execution of a computer program under debug and returns processor control to a debugger. An internal breakpoint inserted by a debugger into computer machine code to implement a step-in function is not visible to a user.

Operating (500) a step-in function of a debugger to cause control flow entry into a program control flow structure according to the example of FIG. 5 includes reading (501) a line number of program code (502) from a machine code and program code map (570). In the example of FIG. 5, machine code and program code map (570) is represented as a data structure that associates a program counter value (571) for a computer machine code instruction with a line number (572) of computer program code. Reading (501) a line number (502) of program code according to the method of FIG. 5 may be carried out by finding a program counter value (571) entry in the machine code and program code map (570) that matches the program counter value for the current computer program instruction to be stepped-into by a debugger step-in function. The line number (572) associated with program counter value (571) in the machine code and program code map (570) is the line number of the current computer program code to be stepped-into by a debugger step-in function.

The method of FIG. 5 includes detecting (520) control flow entry into a program control flow structure. In the example of FIG. 5, all program control flow structures are maintained in a control flow structure table (510). In the example of FIG. 5, control flow structure table (510) associates a program control flow structure identifier (537) with a structure name (516), a type code (515) that indicates the type of control flow structure identified by control flow structure identifier (537), parameters (517) passed to a control flow structure, an exit condition (511) used in exiting a control flow structure, an iteration value (512) that indicates how many times a control flow structure has been repeated, a control flow entry (513) that represents a line number of computer program code where entry to a program control flow structure occurs, and a return point (514) that represents a first line of computer program code after a control flow exit from a control flow structure.

Detecting (520) control flow entry (513) into a program control flow structure according to the method of FIG. 5 may be carried out by scanning the text of line number (502) of computer program code for program control flow structures such as, for example, a function, a loop, or a conditional statement. The following segment of pseudocode illustrates examples of control flow structures.

| | | |
|---|---|---|
| 1 | main( ) | |
| 2 | { | |
| 3 | do_A( ); | |
| 4 | do_B( ); | |
| 5 | for( i = 0; i <= 100; i++ ) | //control flow entry |
| 6 | { | |
| 7 | do_C( ); | |
| 8 | do_D( ); | |
| 9 | for( j = 0; j <= 100; j++ ) | //control flow entry |
| 10 | { | |
| 11 | do_E( ); | |
| 12 | do_F( ); | |
| 13 | } | |
| 14 | do_G( ); | //return point |
| 15 | } | |
| 16 | do_H( ); | //return point |
| 17 | } | |

This example is said to be ‘pseudocode’ because it is an explanation, rather than a working model, set forth in the form of computer program code. This example demonstrates control flow entry (513) and return points (514) useful in debugging a computer program according to embodiments of the present invention. In Example 1 above, lines 5-15 of computer program code depicts a control flow structure, in this example a ‘for loop,’ having a control flow entry at line 5 and a return point at line 16. Similarly, lines 9-13 in this example depict a control flow entry for another loop with its control flow structure entry at line 9 and its return point at line 14.

The method of FIG. 5 includes recording (530) a return point (514) for each control flow entry into a program control flow structure. Recording (530) a return point (514) for each control flow entry into a program control flow structure according to the method of FIG. 5 includes identifying (532) a next line of computer program code after the loop as a return point for the loop. In the method of FIG. 5, identifying (532) a next line of computer program code after the loop as a return point for the loop may be carried out by storing the identified return point in return point (514) of control flow structure table (510).

The method of FIG. 5 includes prompting (540) a user (550) to select a recorded return point (551). Prompting is carried out by, for example, displaying a return point selector window such as the one illustrated at reference (290) on FIG. 2 and allowing a user to select through a GUI one of the one or more return points listed in the return point selector window as a return point for use in continuing execution of a program being debugged. In the example of FIG. 5, user instruction (553) is a data structure that contains a user-selected recorded return point (551) representing a return point (514) selected by a user (550).

The method of FIG. 5 includes, responsive to a user instruction (553) to do so, continuing (560) program execution to a recorded return point. Continuing (560) program execution to a recorded return point according to the method of FIG. 5 includes continuing (562) program execution to a user-selected recorded return point (551) regardless of any intervening user breakpoints. In the method of FIG. 5, continuing (562) program execution to a user-selected recorded return point (551) may be carried out by inserting a user breakpoint at the line of computer program code represented by user-selected recorded return point (551) and executing intervening computer program instructions without stopping on intervening user breakpoints until the user breakpoint at the line of computer program code represented by the user-selected recorded return point (551) is reached.

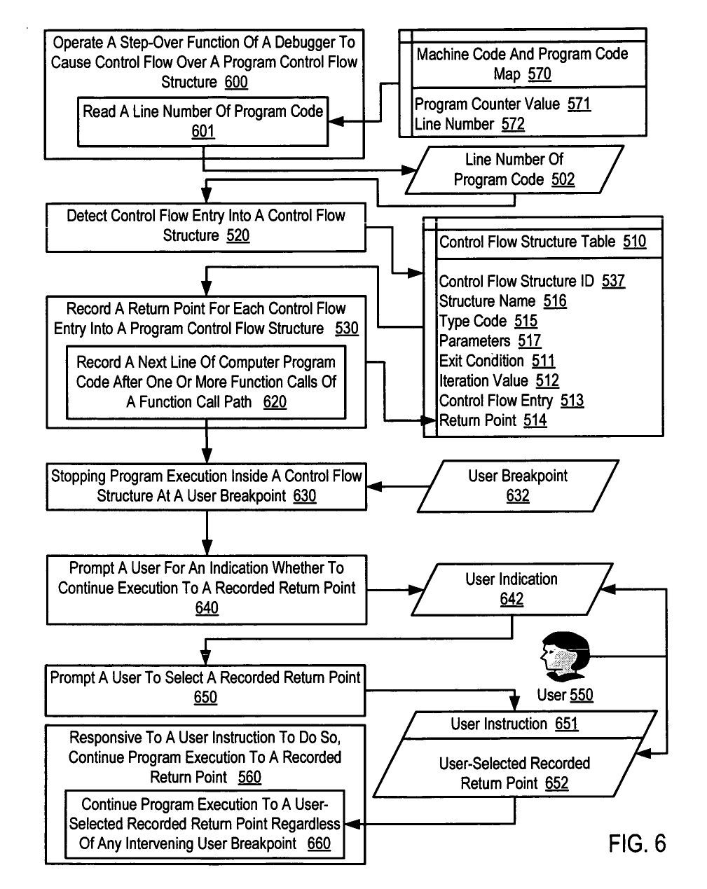

For further explanation, FIG. 6 sets forth a flow chart illustrating a further exemplary method for debugging a computer program according to embodiments of the present invention that include operating (600) a step-over function of a debugger to cause control flow over a program control flow structure, the program control flow structure containing a user breakpoint, detecting (520) control flow entry into a program control flow structure, recording (530) a return point for each control flow entry into a program control flow structure, stopping (630) program execution inside a control flow structure at the user breakpoint, prompting (640) a user for an indication whether to continue execution to a recorded return point, prompting (650) a user to select a recorded return point, and, responsive to a user instruction to do so, continuing (560) program execution to a recorded return point.

The method of FIG. 6 includes operating (600) a step-over function of a debugger to cause control flow over a program control flow structure, the program control flow structure containing a user breakpoint. Operating (600) a step-over function of a debugger according to the method of FIG. 6 may be carried out by a user's operating a GUI button of a user interface that invokes a step-over function of a debugger. Operating (600) a step-over function of a debugger may also be carried out by a user's operating a keyboard shortcut of a user interface that invokes a step-over function of a debugger.

The step-over function of a debugger itself may be implemented as computer program instructions that insert an internal breakpoint at the first statement of the current program control flow structure that follows the control flow structure to be stepped-over using the step-over function. Inserting an internal breakpoint at the first statement of the current program control flow structure that follows the control flow structure to be stepped-over stops execution of a computer program under debug and returns processor control to a debugger.

Operating (600) a step-over function of a debugger to cause control flow over a program control flow structure according to the example of FIG. 6 includes reading (601) a line number of program code (502) from a machine code and program code map (570). In the example of FIG. 6, machine code and program code map (570) is represented as a data structure that associates a program counter value (571) for a computer machine code instruction with a line number (572) of computer program code. Reading (601) a line number (502) of program code according to the method of FIG. 6 may be carried out by finding a program counter value (571) entry in the machine code and program code map (570) that matches the program counter value for the current computer program instruction to be stepped-over by a debugger step-over function. The line number (572) associated with program counter value (571) in the machine code and program code map (570) is the line number of the current computer program code to be stepped-over by a debugger step-over function.

The method of FIG. 6 includes detecting (520) control flow entry into a program control flow structure. In the example of FIG. 6, all program control flow structures are maintained in a control flow structure table (510). In the example of FIG. 6, control flow structure table (510) associates a program control flow structure identifier (537) with a structure name (516), a type code (515) that indicates the type of control flow structure identified by control flow structure identifier (537), parameters (517) passed to a control flow structure, an exit condition (511) used in exiting a control flow structure, an iteration value (512) that indicates how many times a control flow structure has been repeated, a control flow entry (513) that represents a line number of computer program code where entry to a program control flow structure occurs, and a return point (514) that represents a line number of computer program code after a control flow exit from a control flow structure.

Detecting (520) control flow entry (513) into a program control flow structure according to the method of FIG. 6 may be carried out by scanning the text of line number (502) of computer program code for program control flow structures such as, for example, a function, a loop, or a conditional statement. The following segment of pseudocode illustrates examples of control flow structures.

| 1 | main( ) | |
|---|---|---|
| 2 | { | |
| 3 | if Object1.flag then return 0; | |
| 4 | if Object2.flag then return 0; | |
| 5 | do_A( ) | //control flow entry |
| 6 | { | |
| 7 | if Object3.flag then return 0; | |
| 8 | do_B( ) | //control flow entry |
| 9 | { | |
| 10 | if Object4.flag then return 0; | |
| 11 | do_C( ) | //control flow entry |
| 12 | { | |
| 13 | if Object5.flag then return 0; | |
| 14 | } | |
| 15 | return 1; | //return point |
| 16 | } | |
| 17 | return 1; | //return point |
| 18 | } | |
| 19 | return 1; | //return point |
| 20 | } | |

This example demonstrates control flow entry (513) and return points (514) useful in debugging a computer program according to embodiments of the present invention. In this example, line 5 of computer program code depicts a control flow entry (513) for a control flow structure (537) when a program control flow structure (537) is implemented as a function call path. Similarly, lines 8 and 11 in Example 2 also depict control flow entries for function call paths. In this example, line 19 depicts a return point (514) for the function call path entered at line 5. In a similar manner, line 17 depicts a return point (514) for the function call path entered at line 8. Line 15 depicts a return point (514) for the function call path entered at line 11. The computer program code in this example is presented in-line purely for purposes of explanation. Readers of skill in the art will recognize that, although the in-line presentation places the return point for the do_A() call at line 19, the return point would normally occur at line 6. Similarly, a return point for the do_B() call would normally fall at line 9, and a return point for the do_C() call would normally fall at line 12.

The method of FIG. 6 includes recording (530) a return point (514) for each control flow entry into a program control flow structure. Recording (530) a return point (514) for each control flow entry into a program control flow structure according to the method of FIG. 6 includes recording (620) a next line of computer program code after one or more function calls of the function call path. Recording (620) a next line of computer program code after one or more function calls of the function call path may be carried out by storing the next line of computer program code after one or more function calls of the function call path in return point (514) of control flow structure table (510).

The method of FIG. 6 includes stopping (630) program execution inside a control flow structure at a user breakpoint (632). User breakpoint (632) may be, for example, a breakpoint previously set by a user inside a program control flow structure for debugging a computer program. At any rate, user breakpoint (632) in the example of FIG. 6 stops execution inside a control flow structure of a computer program being debugged.

The method of FIG. 6 includes prompting (640) a user (550) for an indication (642) whether to continue execution to a recorded return point. Prompting (640) a user (550) for an indication (642) whether to continue execution to a recorded return point may be carried out by use of a GUI dialog box giving the user an YES/NO choice whether to continue to a recorded return point. User indication (642) is a data structure whose contents, generated by a user's interaction with a dialog box, for example, indicate whether to continue execution to a recorded return point.

The method of FIG. 6 includes prompting (650) a user (550) to select a recorded return point (652). Prompting (650) a user to select a recorded return point according to the method of FIG. 6 may be carried out by displaying a window of a graphical user interface such as, for example, the return point selector window illustrated at reference (290) on FIG. 2 and receiving through a GUI a user's selection of a recorded return point (652). In the example of FIG. 6, user instruction (651) is a data structure that represents a user's instruction to continue execution to a user-selected recorded return point. User instruction (651) contains a user-selected recorded return point (652) identifying a recorded return point (514) selected by a user (550), a recorded return point to which execution will continue according to the method of FIG. 6.

The method of FIG. 6 includes, responsive to a user instruction (652) to do so, continuing (560) program execution to a recorded return point. In particular in the example of FIG. 6, program execution continues to a recorded return point as selected by a user. Continuing (560) program execution to a recorded return point according to the method of FIG. 6 includes continuing (660) program execution to a user-selected recorded return point (652) regardless of any intervening user breakpoint. In the method of FIG. 6, continuing (660) program execution to a user-selected recorded return point (652) may be carried out by inserting a user breakpoint at the statement represented by user-selected recorded return point (652) and executing the path of computer program instructions stopping on intervening user breakpoints until execution arrives at the user breakpoint at the user-selected recorded return point (652).

Exemplary embodiments of the present invention are described largely in the context of a fully functional computer system for debugging a computer program. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for debugging a computer program, the method comprising:
operating a debugger step function;
detecting a governor point by the debugger step function; and
responsive to detecting the governor point, disabling the debugger step function.

2. The method of claim 1 further comprising clearing a debugger input buffer of any pending step commands.

3. The method of claim 1 wherein disabling the debugger step function further comprises disabling the debugger step function pending user authorization to continue stepping.

4. The method of claim 1 wherein disabling the debugger step function further comprises disabling the debugger step function for a predetermined period of time.

5. The method of claim 1 wherein the governor point further comprises an attribute of a user breakpoint.

6. The method of claim 1 wherein the governor point further comprises an attribute of a watch point.

7. The method of claim 1 wherein the governor point further comprises an attribute of a function call.

8. The method of claim 1 wherein the governor point further comprises an attribute of a line of computer program code.

9. An apparatus for debugging a computer program, the apparatus comprising a computer processor and a computer memory operatively coupled to the computer processor, the computer memory having disposed within it computer program instructions capable of:
operating a debugger step function;
detecting a governor point by the debugger step function; and
responsive to detecting the governor point, disabling the debugger step function.

10. The apparatus of claim 9 further comprising computer program instructions capable of clearing a debugger input buffer of any pending step commands.

11. A computer program product for debugging a computer program, the computer program product disposed upon a signal bearing medium, the computer program product comprising computer program instructions capable of:
operating a debugger step function;
detecting a governor point by the debugger step function; and
responsive to detecting the governor point, disabling the debugger step function.

12. The computer program product of claim 11 wherein the signal bearing medium comprises a recordable medium.

13. The computer program product of claim 11 wherein the signal bearing medium comprises a transmission medium.

14. The computer program product of claim 11 further comprising computer program instructions capable of clearing a debugger input buffer of any pending step commands.

15. The computer program product of claim 11 wherein disabling the debugger step function further comprises disabling the debugger step function pending user authorization to continue stepping.

16. The computer program product of claim 11 wherein disabling the debugger step function further comprises disabling the debugger step function for a predetermined period of time.

17. The computer program product of claim 11 wherein the governor point further comprises an attribute of a user breakpoint.

18. The computer program product of claim 11 wherein the governor point further comprises an attribute of a watch point.

19. The computer program product of claim 11 wherein the governor point further comprises an attribute of a function call.

20. The computer program product of claim 11 wherein the governor point further comprises an attribute of a line of computer program code.

21. A method for debugging a computer program, the method comprising:
detecting control flow entry into a program control flow structure;
recording a return point for each control flow entry into a program control flow structure; and
responsive to a user instruction to do so, continuing program execution to a recorded return point.

22. The method of claim 21 further comprising operating a step-in function of a debugger to cause control flow entry into a program control flow structure.

23. The method of claim 22 further comprising:
prompting the user to select a recorded return point; and
wherein continuing program execution to a recorded return point further comprises continuing program execution to a user-selected recorded return point regardless of any intervening user breakpoints.

24. The method of claim 21 further comprising:
operating a step-over function of a debugger to cause control flow over a program control flow structure, the program control flow structure containing a user breakpoint;
stopping program execution inside the control flow structure at the user breakpoint; and
prompting the user for an indication whether to continue execution to a recorded return point.

25. The method of claim 24 further comprising:
prompting the user to select a recorded return point; and
wherein continuing program execution to a recorded return point further comprises continuing program execution to a user-selected recorded return point regardless of any intervening user breakpoints.

26. The method of claim 21 wherein:
at least one program control flow structure is a loop; and
recording a return point for each control flow entry into a program control flow structure further comprises identifying a next line of computer program code after the loop as a return point for the loop.

27. The method of claim 21 wherein:
at least one program control flow structure is a function call path that includes one or more function calls; and
recording a return point for each control flow entry into a program control flow structure further comprises recording a next line of computer program code after one or more function calls of the function call path.
